(19) United States
(12) Patent Application Publication
(10) Pub. No.: US 2015/0195128 A1
(43) Pub. Date: Jul. 9, 2015

(54) APPARATUS AND METHOD FOR SUPPORTING CONFIGURATION MANAGEMENT OF VIRTUAL MACHINE, AND APPARATUS AND METHOD FOR BROKERING CLOUD SERVICE USING THE CONFIGURATION MANAGEMENT SUPPORTING APPARATUS

(71) Applicant: ELECTRONICS AND TELECOMMUNICATIONS RESEARCH INSTITUTE, Daejeon (KR)

(72) Inventors: Nam-Woo KIM, Daejeon (KR); Sung-In JUNG, Daejeon (KR); Jin-Mee KIM, Daejeon (KR); Dong-Jae KANG, Daejeon (KR)

(73) Assignee: ELECTRONICS AND TELECOMMUNICATIONS RESEARCH INSTITUTE, Daejeon (KR)

(21) Appl. No.: 14/591,401

(22) Filed: Jan. 7, 2015

(30) Foreign Application Priority Data
Jan. 8, 2014 (KR) 10-2014-0002468

(51) Int. Cl. H04L 12/24; H04L 29/08

(52) U.S. Cl. CPC H04L 41/0803; H04L 67/10

(57) ABSTRACT

Disclosed herein is an apparatus for supporting automation of configuration management of a virtual machine applicable to a multi-cloud environment. In accordance with an embodiment, the apparatus includes an interface unit for receiving configuration management information or information of a virtual machine to which configuration management is to be applied. A configuration management verification unit verifies the received configuration management information, and combines the virtual machine information with configuration management information corresponding to the virtual machine. A configuration management distribution unit distributes the configuration management information combined with the virtual machine information to a cloud in which the virtual machine is created.

### CROSS REFERENCE TO RELATED APPLICATION

This application claims the benefit of Korean Patent Application No. 10-2014-0002468 filed Jan. 8, 2014, which is hereby incorporated by reference in its entirety into this application.

### BACKGROUND OF THE INVENTION

1. Technical Field

The present invention relates generally to an apparatus and method for supporting the configuration management of a virtual machine, and an apparatus and method for brokering a cloud service using the configuration management supporting apparatus and, more particularly, to technology that automatically supports the configuration management of a virtual machine in a multi-cloud computing environment.

2. Description of the Related Art

Even before the advent of cloud services, a computer manager used various technologies to simultaneously manage a plurality of virtual machines. Such various technologies are used to reduce repetitive tasks and maintain the consistency of a plurality of virtual machine software configurations when a manager manages a plurality of virtual machines. Typical technologies generally adopt a scheme in which contents related to configuration management are previously created and are arranged in a configuration management server, and in which a configuration management agent is installed in a virtual machine, thus enabling configuration management designated by the manager to be incorporated into the virtual machine.

Korean Patent Application Publication No. 10-2013-0022508 discloses typical technology for the configuration management and setting of virtual machines in a cloud computing system. Such typical technologies are inconvenient in that, after a virtual machine has been allocated in the cloud, a server and an agent for configuration management must be personally installed by a user at each time.

### SUMMARY OF THE INVENTION

Accordingly, the present invention has been made keeping in mind the above problems occurring in the prior art, and an object of the present invention is to provide an apparatus and method for supporting the automation of configuration management of a virtual machine, which support configuration management such that the same configuration management designated by a user is applied to each virtual machine in various cloud environments, and an apparatus and method for brokering a cloud service using the automation supporting apparatus.

In accordance with an aspect of the present invention to accomplish the above object, there is provided an apparatus for supporting configuration management of a virtual machine, including an interface unit for receiving configuration management information and information of a virtual machine to which configuration management is to be applied, a configuration management verification unit for verifying the received configuration management information, and combining the virtual machine information with configuration management information corresponding to the virtual machine, and a configuration management distribution unit for distributing the configuration management information combined with the virtual machine information to a cloud in which the virtual machine is created.

The virtual machine information may include one or more of access information and cloud account information of the virtual machine created in the cloud by a user.

The configuration management verification unit may additionally combine information of a configuration management server created in the cloud with the configuration management information combined with the virtual machine information, and the configuration management distribution unit may identify a configuration management server created in the cloud, based on the configuration management server information, and transmits the configuration management information to the identified configuration management server.

The apparatus may further include a configuration management node management unit for managing information of one or more of a configuration management server, a configuration management agent, and a virtual machine created in at least one cloud for each user.

In accordance with another aspect of the present invention to accomplish the above object, there is provided an apparatus for brokering a cloud service, including a cloud broker unit for receiving virtual machine specification and configuration management information from a user, creating a virtual machine in a cloud based on the received virtual machine specification, and transferring information of the created virtual machine or the received configuration management information to a configuration management unit, and the configuration management unit for verifying the configuration management information transferred from the cloud broker unit, combining the virtual machine information with the verified configuration management information, and transmitting combined information to a configuration management server.

The cloud broker unit may be configured to, when the virtual machine specification is received, create the configuration management server in the cloud using a virtual machine image including the configuration management server.

The cloud broker unit may create the virtual machine using a virtual machine image including a configuration management agent.

The configuration management server may identify a configuration management agent based on the virtual machine information combined with the configuration management information received from the configuration management unit, and transmit the configuration management information to the identified configuration management agent, and the configuration management agent may receive the configuration management information from the configuration management server and incorporate the received configuration management information into the virtual machine.

In accordance with a further aspect of the present invention to accomplish the above object, there is provided a method for supporting configuration management of a virtual machine, including receiving configuration management information and information of a virtual machine to which configuration management is to be applied, verifying the received configuration management information, combining the virtual machine information with configuration management information corresponding to the virtual machine, and distributing the configuration management information combined with the virtual machine information to a cloud in which the virtual machine is created.

The virtual machine information may include one or more of access information and cloud account information of the virtual machine created in the cloud by a user.

The method may further include additionally combining information of a configuration management server with the configuration management information combined with the virtual machine information, wherein distributing the configuration management information may include identifying a configuration management server of a user created in the cloud, based on the configuration management server information, and transmitting the configuration management information to the identified configuration management server.

In accordance with yet another aspect of the present invention to accomplish the above object, there is provided a method for brokering a cloud service, the method being performed by an apparatus for brokering a cloud service, including receiving virtual machine specification and configuration management information from a user, creating a virtual machine in a cloud based on the received virtual machine specification, verifying the received configuration management information, combining information of the virtual machine created in the cloud with the verified configuration management information, and distributing the configuration management information combined with the virtual machine information to a configuration management server.

The method may further include, when the virtual machine specification is received, creating the configuration management server using a virtual machine image including the configuration management server.

Creating the virtual machine may include creating the virtual machine using a virtual machine image including a configuration management agent.

The method may further include identifying, by the configuration management server, a configuration management agent based on the virtual machine information combined with the received configuration management information, transmitting, by the configuration management server, the configuration management information to the identified configuration management agent, and incorporating, by the configuration management agent, the configuration management information received from the configuration management server into the virtual machine.

### BRIEF DESCRIPTION OF THE DRAWINGS

FIG. 1 is a diagram showing an apparatus for supporting the configuration management of a virtual machine according to an embodiment;

FIG. 2 is a diagram showing an apparatus for brokering a cloud service according to an embodiment;

FIG. 3 is a diagram showing an apparatus for brokering a cloud service according to another embodiment;

FIG. 4 is a flowchart showing a method for supporting the configuration management of a virtual machine according to an embodiment;

FIG. 5 is a flowchart showing a method for brokering a cloud service according to an embodiment; and

FIG. 6 is a flowchart showing a procedure by which configuration management information is applied to a virtual machine according to an embodiment.

### DESCRIPTION OF THE PREFERRED EMBODIMENTS

Details of other embodiments will be included in the following detailed description and attached drawings. The features and advantages of the described disclosure and method for accomplishing them will be more clearly understood from embodiments taken in conjunction with the accompanying drawings. It should be noted that the same reference numerals are used to designate the same or similar elements throughout the drawings and the present specification.

Hereinafter, embodiments of an apparatus and method for supporting the configuration management of a virtual machine, and an apparatus and method for brokering a cloud service using the configuration management supporting apparatus will be described in detail with reference to the attached drawings.

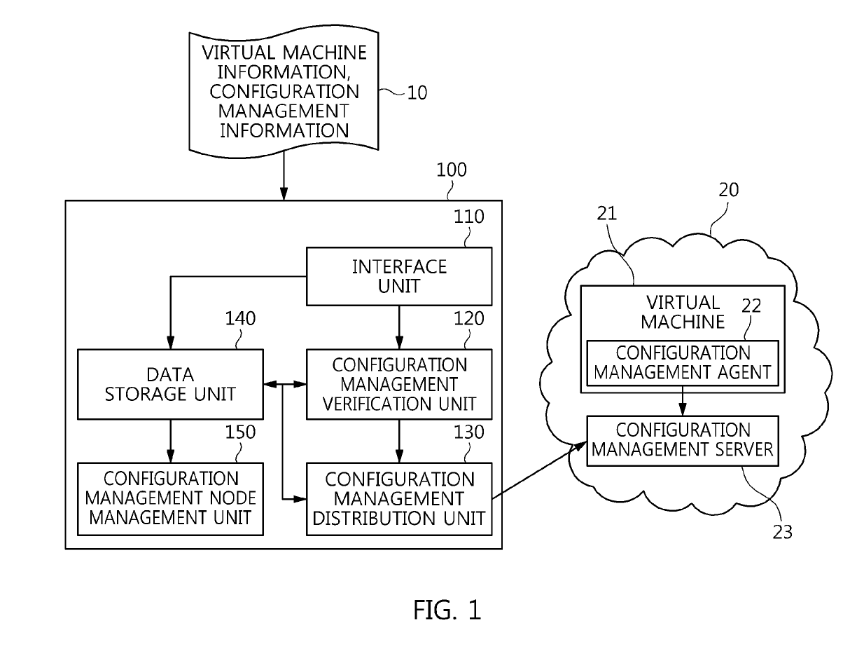

FIG. 1 is a diagram showing an apparatus for supporting the configuration management of a virtual machine according to an embodiment of the present invention.

As shown in FIG. 1, an apparatus 100 for supporting the configuration management of a virtual machine may support the configuration management of a virtual machine 21 previously created in a cloud 20 at the request of a user.

The cloud 20 of FIG. 1 exemplifies a case where a single virtual machine 21 is created for a user. However, the created virtual machine is not limited thereto, and one or more virtual machines 21 may be created for each user.

Further, as shown in the drawing, the virtual machine 21 may include a configuration management agent 22 to effectively support configuration management. A configuration management server 23 may be created in advance for the user. In this case, one configuration management server 23 for each user may be created in the cloud 20. The configuration management agent 22 accesses the configuration management server 23 to receive configuration management information of a required virtual machine 21, and configures the environment of the virtual machine 21 into a service-available state using the received configuration management information.

Referring to FIG. 1, the apparatus 100 for supporting the configuration management of a virtual machine includes an interface unit 110, a configuration management verification unit 120, a configuration management distribution unit 130, a data storage unit 140, and a configuration management node management unit 150.

The interface unit 110 receives information 10 required for the configuration management of the virtual machine 21 created in the cloud 20 by the user. The interface unit 110 receives the information 10 required for configuration management either directly from the user or from an associated external module as necessary.

In this case, the information 10 required for configuration management includes virtual machine information of the virtual machine 21 which is created in the cloud 20 and to which configuration management is to be applied, for example, virtual machine access information and cloud account information; and configuration management information which is to be applied to the virtual machine 21, for example, installation information for an application program or the like. In this case, the installation information for the application program may include the installation script of the application program, created by the user.

The interface unit 110 is configured to, when the information 10 required for configuration management is received, store and manage the information 10 required for configuration management, for example, configuration management information, virtual machine information, etc., in the data storage unit 140.

In this case, the virtual machine information and the configuration management information are not necessarily limited to be simultaneously input. That is, the user may previously input his or her desired configuration management information and allow the input information to be managed by the data storage unit 140. Whenever an addition or a change occurs in the configuration management information, the user may input the added or changed configuration management information.

Thereafter, when the user creates the virtual machine 21 in the cloud 20, the user may make a request such that configuration management information is incorporated into the virtual machine 21 by inputting virtual machine information of the virtual machine 21.

The configuration management verification unit 120 verifies the input configuration management information. That is, the configuration management verification unit 120 may verify whether an error occurs in the configuration management information created by the user, for example, in the installation script of the application program, and whether configuration management is secure when being applied to the virtual machine 21.

When the configuration management information is verified, the configuration management verification unit 120 may store and manage the results of verification in the data storage unit 140.

The configuration management verification unit 120 is configured to, when virtual machine information of the virtual machine 21 to which configuration management is to be applied is input, combine the virtual machine information with the verified configuration management information to be applied to the virtual machine 21.

In this case, the configuration management verification unit 120 may check the information of the configuration management server 23 previously created in the cloud 20 for the user, among pieces of configuration management node information stored in the data storage unit 140, and may additionally combine the information of the configuration management server 23 with the configuration management information which has been combined with the virtual machine information.

The configuration management verification unit 120 may transfer the configuration management information, with which the virtual machine information and the configuration management server information are combined, to the configuration management distribution unit 130 so that the combined configuration management information is distributed to the cloud 20.

The configuration management distribution unit 130 distributes the configuration management information received from the configuration management verification unit 120 to the cloud 20, thus enabling the configuration management information to be applied to the virtual machine 21.

In this case, the configuration management distribution unit 130 may identify a configuration management server 23 to which the received configuration management information is to be transferred by checking the configuration management server information combined with the configuration management information and may transmit the configuration management information to the identified configuration management server 23.

The configuration management node management unit 150 may collect information of the virtual machine 21 of the user, the configuration management agent 22, and the configuration management server 23, which are created in the cloud 20, and may store and manage the collected information in the data storage unit 140.

The configuration management node management unit 150 may collect information of virtual machines of users created in various other types of clouds of a cloud service provider, as well as the cloud 20 shown in FIG. 1, configuration management agents included in the virtual machines, and configuration management servers created for users, and may manage the collected information for each user.

In this case, as described above, the virtual machine information may include a cloud account, virtual machine access information, a virtual machine ID, etc., and the configuration management agent information may include information of a configuration management agent ID and a virtual machine ID corresponding to the configuration management agent ID. Further, the configuration management server information may include the name of each configuration management server, the access information of the configuration management server, etc.

The configuration management node management unit 150 may additionally manage, for respective users, virtual machine images including configuration management agents and virtual machine images including configuration management servers.

The configuration management server 23 of the user, created in the cloud 20, receives configuration management information from the configuration management distribution unit 130, and manages the configuration management information.

The configuration management server 23 may be configured to, when a configuration management information request is received from the configuration management agent 22, or when new configuration management information is received from the configuration management distribution unit 130, identify a configuration management agent, based on the virtual machine information combined with the configuration management information, and transmit the configuration management information to the identified configuration management agent.

The configuration management agent 22 accesses the configuration management server 23, receives required configuration management information from the configuration management server 23, and incorporates the received information into the virtual machine 21.

In this way, in accordance with the disclosed embodiment, the user may create the virtual machine 21 in the cloud 20, and may automatically configure the environment of the virtual machine 21 created in the cloud 20 by inputting the virtual machine information of the virtual machine and the configuration management information to be applied to the virtual machine.

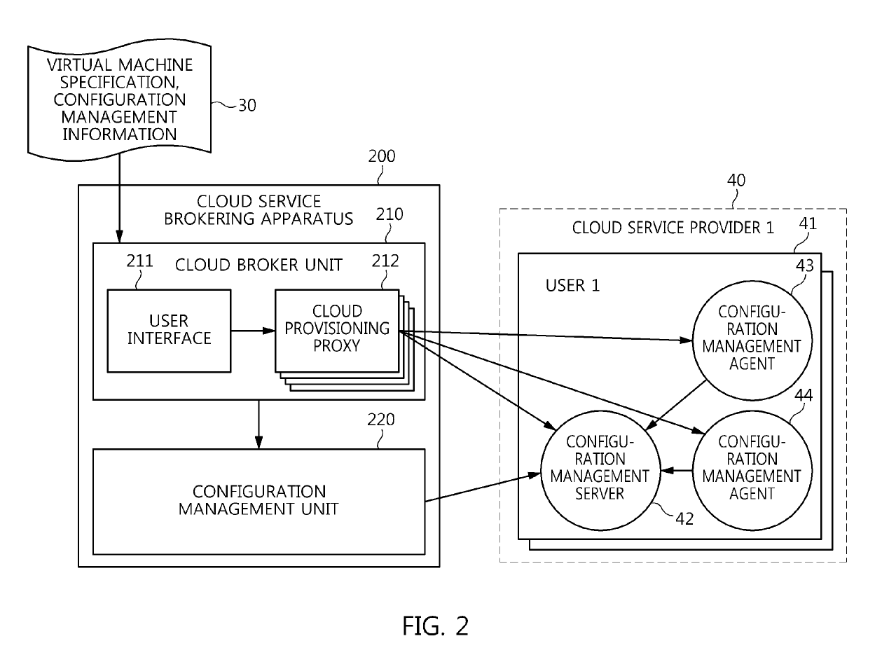

FIG. 2 is a diagram showing an apparatus for brokering a cloud service according to an embodiment. More specifically, FIG. 2 illustrates a cloud service environment for describing an apparatus 200 for brokering a cloud service (hereinafter referred to as a “cloud service brokering apparatus”) to which the apparatus 100 for supporting configuration management according to the embodiment of FIG. 1 is applied.

Referring to FIG. 2, the cloud service brokering apparatus 200 includes a cloud broker unit 210 and a configuration management unit 220. In this case, the configuration management unit 220 may be the apparatus 100 for supporting the configuration management of a virtual machine according to the embodiment of FIG. 1.

The cloud broker unit 210 may receive virtual machine-related information 30 to be created in a cloud 40 provided by a first cloud service provider from a first user through a user interface 211.

In this case, the information 30 received from the first user may include virtual machine specification and configuration management information to be applied to the virtual machine.

When the virtual machine specification is input from the first user, the cloud broker unit 210 invokes a cloud provisioning proxy, and creates a virtual machine system 41 for the first user in the cloud 40 designated by the first user through the cloud provisioning proxy. In this case, the virtual machine system 41 of the first user may include a configuration management server 42 and one or more virtual machines 43 and 44, each including a configuration management agent.

For example, the cloud broker unit 210 may create the configuration management server 42 for the first user in the cloud 40, designated by the first user through the cloud provisioning proxy, using a virtual machine image including the configuration management server. Then, the cloud broker unit 210 may create one or more virtual machines 43 and 44, requested by the first user, in the cloud 40 using a virtual machine image including the configuration management agents.

The cloud broker unit 210 is configured to, when the creation of the virtual machines 43 and 44 in the cloud 40 at the request of the first user is completed, transfer virtual machine information of the created virtual machines 43 and 44 and the received configuration management information to the configuration management unit 220.

The configuration management unit 220 is configured to verify the received configuration management information, and if the verification of the configuration management information is completed, combine the virtual machine information with the configuration management information, and transmit the combined configuration management information to the configuration management server 42 created for the user.

As described above, the configuration management unit 220 may be the configuration management supporting apparatus 100 of FIG. 1, and thus a detailed description thereof will be omitted here.

When receiving configuration management information from the configuration management unit 220, the configuration management server 42 of the virtual machine system 41 for the first user, created in the cloud 40, may store and manage the configuration management information in a database (DB) (not shown).

The configuration management agent included in each virtual machine 43 or 44 accesses the configuration management server 42, receives required configuration management information from the configuration management server 42, and applies the configuration management information to its own virtual machine 43 or 44.

In this case, the configuration management server 42 may identify the corresponding configuration management agent using the virtual machine information combined with the configuration management information, and transmit configuration management information corresponding to the configuration management agent.

Meanwhile, the first user may create two virtual machines 43 and 44 in the cloud 40 at different times. That is, the first user may primarily apply configuration management to the virtual machine 43, as described above, by inputting the virtual machine specification and configuration management information of the virtual machine 43. Thereafter, the first user may create the virtual machine 44 by inputting the virtual machine specification of the virtual machine 44, and secondarily apply configuration management to the virtual machine 44 using previously input configuration management information.

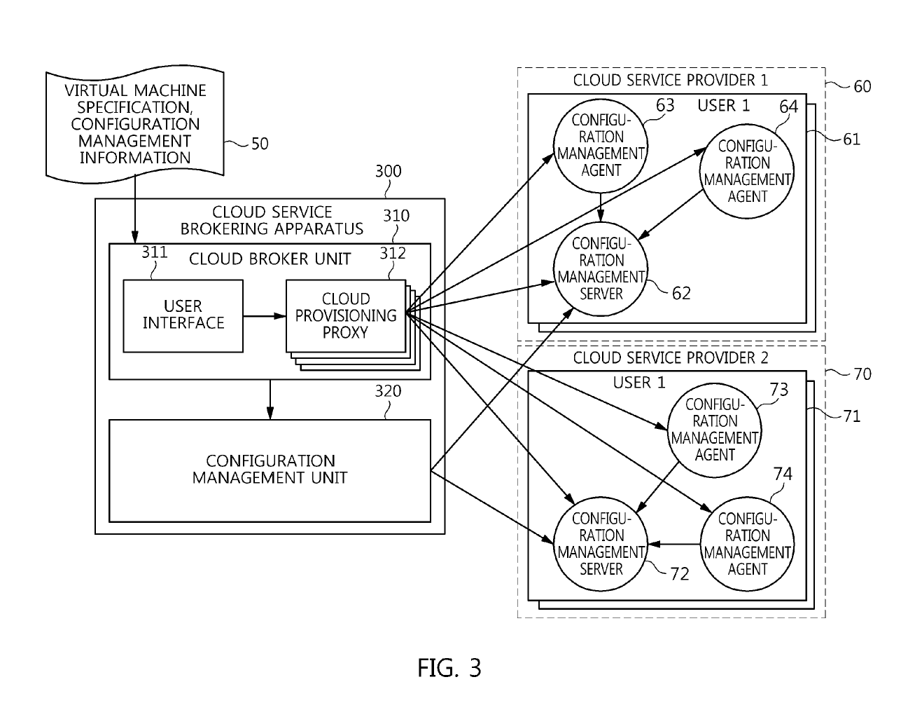

FIG. 3 is a diagram showing an apparatus for brokering a cloud service according to another embodiment.

More specifically, FIG. 3 illustrates a cloud service brokering apparatus 300 applicable to a multi-cloud environment, especially, an environment of heterogeneous clouds.

As described above, the cloud service brokering apparatus 300 may receive virtual machine-related information 50, such as virtual machine specification and configuration management information, from a first user either at the same time or at different times, and may create virtual machine systems 61 and 71 of the first user in multiple clouds 60 and 70.

In this case, the clouds 60 and 70 may be heterogeneous clouds in such a way that the cloud 60 is provided by a first cloud service provider and the cloud 70 is provided by a second cloud service provider.

An example of extension of a cloud service performed by the cloud service brokering apparatus 300 in a multi-cloud environment will be described with reference to FIG. 3.

As shown in the drawing, the cloud service brokering apparatus 300 includes a cloud broker unit 310 and a configuration management unit 320.

First, the cloud broker unit 310 receives information 50, required to create the virtual machine system 61 in the cloud 60 provided by the first cloud service provider, from the first user through a user interface 311.

The cloud broker unit 310 creates a configuration management server 62 and virtual machines 63 and 64, each including a configuration management agent, in the cloud 60 designated by the first user, using the input virtual machine specification. In this case, as described above, the virtual machines 63 and 64 may be created either at the same time or at different times.

Then, the cloud broker unit 310 transfers information of the created virtual machines 63 and 64 and the configuration management information to the configuration management unit 320.

The configuration management unit 320 verifies the received configuration management information, combines the virtual machine information with the configuration management information, and transmits the combined information to the configuration management server 62 created in the cloud 60.

As described above, the configuration management server 62 transmits the configuration management information corresponding to the accessed configuration management agent, and then allows the configuration management information to be incorporated into the virtual machines 63 and 64.

Thereafter, when the first user desires to create a virtual machine in the cloud 70 provided by a second cloud service provider, the first user may create a virtual machine system 71 in the cloud 70 by inputting the virtual machine specification 50 of a virtual machine to be created, and may make a request so that configuration management is applied to the virtual machines 73 and 74.

Similarly, the first user may input the virtual machine specification of the virtual machine 73 and the virtual machine specification of the virtual machine 74 at different times.

In this way, when the request is received from the first user, the cloud broker unit 310 creates the configuration management server 72 and the virtual machines 73 and 74 in the cloud 70 designated by the user.

Thereafter, the configuration management unit 320 is configured to, when the information of a virtual machine to which configuration management is to be applied is received from the cloud broker unit 310, check previously stored configuration management information, combine the virtual machine information with the configuration management information to be applied, and transmit the combined information to the configuration management server 72, thus enabling configuration management to be applied to each of the virtual machines 73 and 74.

In accordance with the disclosed embodiment, the user does not need to personally create virtual machines in the cloud and to personally configure the environment of the virtual machines, thus enabling the cloud service to be easily extended even in a multi-cloud environment.

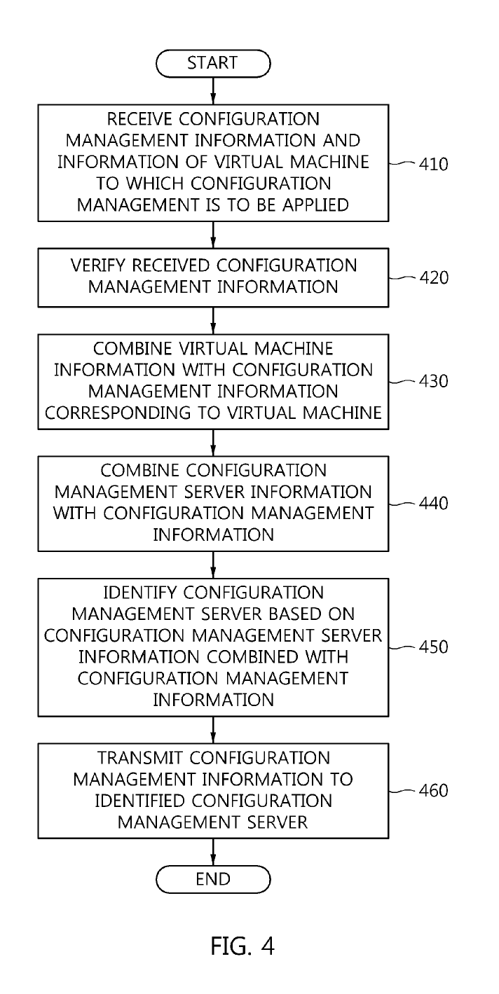

FIG. 4 is a flowchart showing a method for supporting the configuration management of a virtual machine according to an embodiment.

More specifically, FIG. 4 illustrates an embodiment of a method for supporting the configuration management of the virtual machine, performed by the configuration management supporting apparatus 100 of FIG. 1.

First, the configuration management supporting apparatus 100 receives information of a virtual machine to which configuration management is to be applied, for example, configuration management information and virtual machine information, from a user at step 410.

In this case, the virtual machine information may include virtual machine access information, cloud account information, etc., and the configuration management information may include installation information for an application program, that is, the installation script of the application program, created by the user.

Then, the configuration management supporting apparatus 100 verifies whether an error occurs in the input configuration management information, for example, the installation script of the application program, or whether configuration management is secure when being applied to the virtual machine at step 420.

Thereafter, the configuration management supporting apparatus 100 combines information of a virtual machine to which configuration management is to be applied with the configuration management information to be applied to the virtual machine at step 430.

The configuration management supporting apparatus 100 may combine the information of a configuration management server, to which the configuration management information is to be transmitted, with the configuration management information at step 440. In this case, the information of respective configuration management servers created in clouds for each user is checked, and thus the information of a configuration management server created in the corresponding cloud may be combined with the configuration management information.

Next, the configuration management supporting apparatus 100 may identify the configuration management server by checking the configuration management server information combined with the configuration management information at step 450. The configuration management information is transmitted to the identified configuration management server, so that the configuration management information is applied to the virtual machine of the corresponding cloud at step 460.

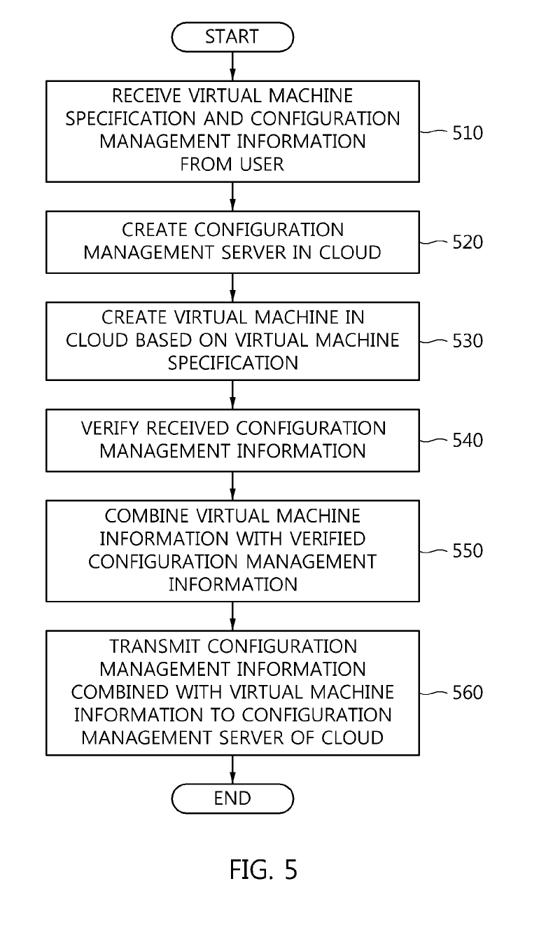

FIG. 5 is a flowchart showing a method for brokering a cloud service according to an embodiment.

More specifically, FIG. 5 illustrates an embodiment of a method for brokering a cloud service, performed by the cloud service brokering apparatus 200 or 300 according to the embodiment of FIG. 2 or 3.

First, the cloud broker unit receives the virtual machine specification and configuration management information of a virtual machine to be created from the user at step 510.

When the virtual machine specification is received from the user, the cloud broker unit creates a configuration management server in a cloud designated by the user at step 520. In this case, the cloud broker unit may invoke a cloud provisioning proxy and create the configuration management server in the cloud designated by the user through the cloud provisioning proxy.

Next, the cloud broker unit may create one or more virtual machines in the cloud through the cloud provisioning proxy at step 530.

Then, when the virtual machines are created by the cloud broker unit, the configuration management unit may receive the input configuration management information and created virtual machine information, and may verify the input configuration management information at step 540.

Thereafter, the configuration management unit combines the virtual machine information with the verified configuration management information at step 550, and transmits the combined configuration management information to the configuration management server created in the cloud for the user at step 560.

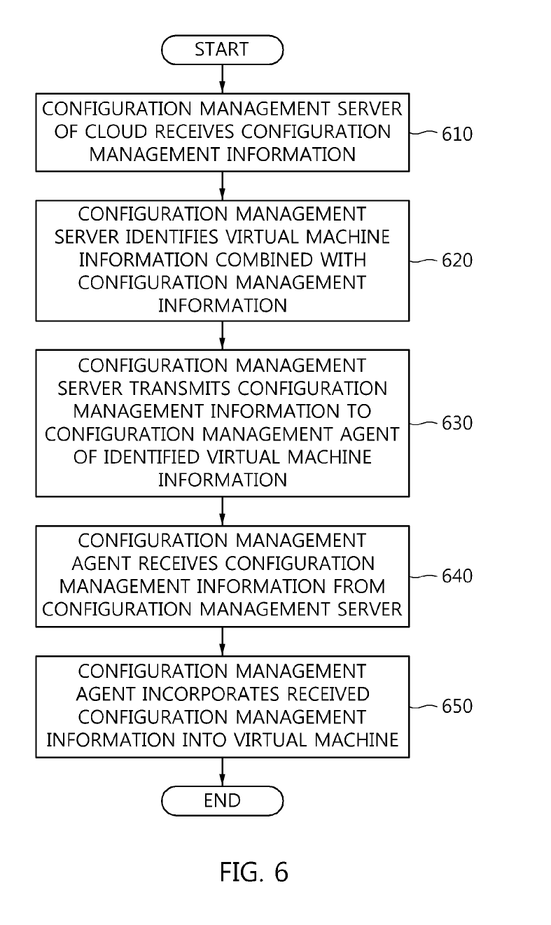

FIG. 6 is a flowchart showing a procedure by which configuration management information is applied to a virtual machine according to an embodiment.

More particularly, FIG. 6 illustrates a procedure by which configuration management information is applied to a virtual machine in the cloud after step 460 or 560 according to the embodiment of FIG. 4 or 5.

First, the configuration management server of the cloud receives configuration management information at step 610.

The configuration management server identifies virtual machine information combined with the received configuration management information at step 620.

Thereafter, the configuration management server transmits the configuration management information to a configuration management agent included in the identified virtual machine among accessed configuration management agents at step 630.

Next, the configuration management agent receives the configuration management information from the configuration management server at step 640, and incorporates the configuration management information into the virtual machine at step 650.

In accordance with the present invention, the automation of configuration management may be supported so that the same configuration management designated by a user is automatically applied to each virtual machine in various cloud environments.

Further, the present invention may be utilized even in a single cloud, an interoperable cloud, and a cloud service broker, and may easily apply once-created configuration management information to heterogeneous clouds.

Furthermore, the present invention may promptly extend a cloud service with a minimum of manpower in an environment requiring the extension of a cloud service all over the world and may facilitate management and maintenance.

Those skilled in the art to which the present embodiments pertain will appreciate that the present invention may be practiced in other specific forms without departing from the technical spirit or essential features of the invention. Therefore, the above-described embodiments should be understood to be exemplary, rather than restrictive, in all aspects.

What is claimed is:

1. An apparatus for supporting configuration management of a virtual machine, comprising:
an interface unit for receiving configuration management information and information of a virtual machine to which configuration management is to be applied;
a configuration management verification unit for verifying the received configuration management information, and combining the virtual machine information with configuration management information corresponding to the virtual machine; and
a configuration management distribution unit for distributing the configuration management information combined with the virtual machine information to a cloud in which the virtual machine is created.

2. The apparatus of claim 1, wherein the virtual machine information includes one or more of access information and cloud account information of the virtual machine created in the cloud by a user.

3. The apparatus of claim 1, wherein:
the configuration management verification unit additionally combines information of a configuration management server created in the cloud with the configuration management information combined with the virtual machine information, and
the configuration management distribution unit identifies a configuration management server created in the cloud, based on the configuration management server information, and transmits the configuration management information to the identified configuration management server.

4. The apparatus of claim 1, further comprising a configuration management node management unit for managing information of one or more of a configuration management server, a configuration management agent, and a virtual machine created in at least one cloud for each user.

5. An apparatus for brokering a cloud service, comprising:
a cloud broker unit for receiving virtual machine specification and configuration management information from a user, creating a virtual machine in a cloud based on the received virtual machine specification, and transferring information of the created virtual machine or the received configuration management information to a configuration management unit; and
the configuration management unit for verifying the configuration management information transferred from the cloud broker unit, combining the virtual machine information with the verified configuration management information, and transmitting combined information to a configuration management server.

6. The apparatus of claim 5, wherein the cloud broker unit is configured to, when the virtual machine specification is received, create the configuration management server in the cloud using a virtual machine image including the configuration management server.

7. The apparatus of claim 5, wherein the cloud broker unit creates the virtual machine using a virtual machine image including a configuration management agent.

8. The apparatus of claim 5, wherein:
the configuration management server identifies a configuration management agent based on the virtual machine information combined with the configuration management information received from the configuration management unit, and transmits the configuration management information to the identified configuration management agent, and
the configuration management agent receives the configuration management information from the configuration management server and incorporates the received configuration management information into the virtual machine.

9. A method for supporting configuration management of a virtual machine, comprising:
receiving configuration management information and information of a virtual machine to which configuration management is to be applied;
verifying the received configuration management information;
combining the virtual machine information with configuration management information corresponding to the virtual machine; and
distributing the configuration management information combined with the virtual machine information to a cloud in which the virtual machine is created.

10. The method of claim 9, wherein the virtual machine information includes one or more of access information and cloud account information of the virtual machine created in the cloud by a user.

11. The method of claim 9, further comprising additionally combining information of a configuration management server with the configuration management information combined with the virtual machine information,
wherein distributing the configuration management information comprises:
identifying a configuration management server of a user created in the cloud, based on the configuration management server information; and
transmitting the configuration management information to the identified configuration management server.

12. A method for brokering a cloud service, the method being performed by an apparatus for brokering a cloud service, comprising:
receiving virtual machine specification and configuration management information from a user;
creating a virtual machine in a cloud based on the received virtual machine specification;
verifying the received configuration management information;
combining information of the virtual machine created in the cloud with the verified configuration management information; and
distributing the configuration management information combined with the virtual machine information to a configuration management server.

13. The method of claim 12, further comprising, when the virtual machine specification is received, creating the configuration management server using a virtual machine image including the configuration management server.

14. The method of claim 12, wherein creating the virtual machine comprises creating the virtual machine using a virtual machine image including a configuration management agent.

15. The method of claim 12, further comprising:
identifying, by the configuration management server, a configuration management agent based on the virtual machine information combined with the received configuration management information;
transmitting, by the configuration management server, the configuration management information to the identified configuration management agent; and
incorporating, by the configuration management agent, the configuration management information received from the configuration management server into the virtual machine.
